(19) United States
(12) Patent Application Publication
(10) Pub. No.: US 2012/0298403 A1
(43) Pub. Date: Nov. 29, 2012

(54) STRANDED THERMOPLASTIC POLYMER COMPOSITE CABLE, METHOD OF MAKING AND USING SAME

(76) Inventors: Douglas E. Johnson, St. Paul, MN (US); James P. Sorensen, Eagan, MN (US); Per M. Nelson, St. Paul, MN (US); Michael F. Grether, St. Paul, MN (US)

(21) Appl. No.: 13/576,349

(22) PCT Filed: Jan. 24, 2011
(86) PCT No.: PCT/US11/22208

§ 371 Date: Jul. 31, 2012

Related U.S. Application Data
(60) Provisional application No. 61/291,665, filed on Feb. 1, 2010.

(51) Int. Cl. H01B 5/10; D02G 3/02

(52) U.S. Cl. 174/130; 57/362

(57) ABSTRACT

Helically stranded thermoplastic polymer composite cable (10) includes a single wire (2) defining a center longitudinal axis, a first multiplicity of thermoplastic polymer composite wire (4) helically stranded around the single wire (2), and a second multiplicity of polymer composite wire (6) helically stranded around the first multiplicity of thermoplastic polymer composite wire (4). The helically stranded thermoplastic polymer composite cable (10) may be used as intermediate articles that are later incorporated into final articles, such as electrical power transmission cables, including underwater tethers and underwater umbilicals. Methods of making and using the helically stranded thermoplastic polymer composite cables are also described.

### CROSS REFERENCE TO RELATED APPLICATION

This application claims the benefit of U.S. Provisional Patent Application No. 61/291,665, filed Feb. 1, 2010, the disclosure of which is incorporated by reference herein in its entirety.

### TECHNICAL FIELD

The present disclosure relates generally to stranded cables and their method of manufacture and use. The disclosure further relates to stranded cables with helically stranded polymer composite wires and their method of manufacture and use. Such helically stranded polymer composite cables are useful in electrical power transmission cables, underwater tethers and underwater umbilicals and other applications.

### BACKGROUND

Cable stranding is a process in which individual wires are combined, typically in a helical arrangement, to produce a finished cable. See, e.g., U.S. Pat. Nos. 5,171,942 and 5,554,826. The resulting stranded cable or wire rope provides far greater flexibility than would be available from a solid rod of equivalent cross sectional area. The stranded arrangement is also beneficial because a helically stranded cable maintains its overall round cross-sectional shape when the cable is subject to bending in handling, installation and use. Such helically stranded cables are used in a variety of applications such as hoist cables, aircraft cables, and power transmission cables.

Helically stranded cables are typically produced from ductile metals such as steel, aluminum, or copper. In some cases, such as bare overhead electrical power transmission cables, a helically stranded wire core is surrounded by a wire conductor layer. The helically stranded wire core could comprise ductile metal wires made from a first material such as steel, for example, and the outer power conducting layer could comprise ductile metal wires made from another material such as aluminum, for example. In some cases, the helically stranded wire core may be a pre-stranded cable used as an input material to the manufacture of a larger diameter electrical power transmission cable. Helically stranded cables generally may comprise as few as seven individual wires to more common constructions containing 50 or more wires.

During the cable stranding process, ductile metal wires are subjected to stresses beyond the yield stress of the metal material but below the ultimate or failure stress. This stress acts to plastically deform the metal wire as it is helically wound about the relatively small radius of the preceding wire layer or center wire. There have been recently introduced useful cables made using wires made from materials that cannot readily be plastically deformed to a new shape, and which may be brittle.

One example of such composite cables is provided by a metal matrix composite cable containing fiber reinforced metal matrix composite wires. Such metal matrix composite wires are attractive due to their improved mechanical properties relative to ductile metal wires, but which are primarily elastic in their stress strain response. Some polymer composite cables containing fiber reinforced polymer matrix wires are also known in the art, such as the thermosetting polymer matrix composite wires disclosed in, for example, U.S. Pat. Nos. 6,559,385 and 7,093,416; and PCT International Pub. No. WO 97/00976. One use of a stranded composite cables (e.g., cables containing polymer matrix composite or metal matrix composite wires) is as a reinforcing member in bare electrical power transmission cables.

### SUMMARY

In one aspect, the present disclosure provides an improved stranded thermoplastic polymer composite cable. In some exemplary embodiments, the stranded thermoplastic polymer composite cable comprises a single wire defining a center longitudinal axis, a first plurality of thermoplastic polymer composite wires stranded around the composite wire in a first lay direction at a first lay angle defined relative to the center longitudinal axis and having a first lay length, and a second plurality of thermoplastic polymer composite wires stranded around the first plurality of thermoplastic polymer composite wires in a second lay direction at a second lay angle defined relative to the center longitudinal axis and having a second lay length.

In further exemplary embodiments, the stranded cable further comprises a third plurality of thermoplastic polymer composite wires stranded around the second plurality of thermoplastic polymer composite wires in a third lay direction at a third lay angle defined relative to the center longitudinal axis and having a third lay length. In additional exemplary embodiments, the stranded cable further comprises a fourth plurality of thermoplastic polymer composite wires stranded around the third plurality of thermoplastic polymer composite wires in a fourth lay direction at a fourth lay angle defined relative to the center longitudinal axis and having a fourth lay length. In additional exemplary embodiments, the stranded thermoplastic polymer composite cable may further comprise additional thermoplastic polymer composite wires stranded around the fourth plurality of polymer composite wires.

In any of the foregoing exemplary embodiments, the first lay direction may be the same as the second lay direction, the third lay direction may be the same as the second lay direction, the fourth lay direction may the same as the third lay direction, and in general, any outer layer lay direction may be the same as the adjacent inner layer lay direction.

In other exemplary embodiments, the second lay direction is opposite that of the first lay direction, the third lay direction is opposite that of the second lay direction (i.e. the third lay direction is in the same direction as the first lay direction), the fourth lay direction is opposite that of the third lay direction (i.e. the fourth lay direction is in the same direction as the second lay direction), and in general, any outer layer lay direction may be selected to be opposite that of an adjacent inner layer direction. Furthermore, in certain presently preferred embodiments, the relative difference between the first lay angle and the second lay angle may be greater than 0° and no greater than about 4°, the relative difference between the third lay angle and the second lay angle may be greater than 0° and no greater than about 4°, the relative difference between the fourth lay angle and the third lay angle may be greater than 0° and no greater than about 4°, and in general, any inner layer lay angle and the adjacent outer layer lay angle, may be greater than 0° and no greater than about 4°, more preferably no greater than 3°, most preferably no greater than 0.5°.

In further embodiments, one or more of the first lay length is less than or equal to the second lay length, the second lay length is less than or equal to the third lay length, the fourth lay length is less than or equal to an immediately subsequent lay length, and/or each succeeding lay length is less than or equal to the immediately preceding lay length. In other embodiments, one or more of the first lay length equals the second lay length, the second lay length equals the third lay length, and the third lay length equals the fourth lay length. In some exemplary embodiments, it may be preferred to use a parallel lay, as is known in the art.

In a further aspect, the present disclosure provides alternative embodiments of a stranded electrical power transmission cable comprising a core and a conductor layer around the core, in which the core comprises any of the above-described stranded thermoplastic polymer composite cables. In some exemplary embodiments, the stranded cable further comprises a plurality of ductile metal wires stranded around the stranded thermoplastic polymer composite wires of the stranded thermoplastic polymer composite cable core.

In certain exemplary embodiments, the plurality of ductile metal wires is stranded about the center longitudinal axis in a plurality of radial layers surrounding the thermoplastic polymer composite wires of the thermoplastic polymer composite cable core. In additional exemplary embodiments, at least a portion of the plurality of ductile metal wires is stranded in the first lay direction at a lay angle relative to the center longitudinal axis, and at a first lay length of ductile metal wires. In other exemplary embodiments, at least a portion of the plurality of ductile metal wires is stranded in a second lay direction at a lay angle defined relative to the center longitudinal axis, and at a second lay length of ductile metal wires.

In any of the above embodiments of helically stranded polymer composite cables and their related embodiments of stranded electrical power transmission cables, the following exemplary embodiments may be employed advantageously. Thus, in one exemplary embodiment, the single wire has a cross-sectional shape taken in a direction substantially normal to the center longitudinal axis that is circular or elliptical. In certain exemplary embodiments, the single wire is a polymer composite wire. In certain presently preferred embodiments, the single wire is a ductile metal wire, or a thermoplastic polymer composite wire. In additional exemplary embodiments, each polymer composite wire and/or ductile wire has a cross-section, in a direction substantially normal to the center longitudinal axis, selected from circular, elliptical, and trapezoidal.

In an additional aspect, the disclosure provides a method of making the stranded cable as described in any of the above aspects and embodiments, the method comprising helically stranding a first plurality of thermoplastic polymer composite wires about a single wire defining a center longitudinal axis, wherein helically stranding the first plurality of thermoplastic polymer composite wires is carried out in a first lay direction at a first lay angle defined relative to the center longitudinal axis, wherein the first plurality of wires have a first lay length; helically stranding a second plurality of thermoplastic polymer composite wires around the first plurality of thermoplastic polymer composite wires, wherein helically stranding the second plurality of thermoplastic polymer composite wires is carried out in the first lay direction at a second lay angle defined relative to the center longitudinal axis, and wherein the second plurality of wires has a second lay length; and heating the helically stranded first and second plurality of thermoplastic polymer composite wires to a temperature sufficient and a time sufficient to retain the helically stranded polymer composite wires in a helically stranded configuration upon cooling to 25° C. A presently preferred temperature is 300° C.

In certain presently preferred exemplary embodiments, the relative difference between the first lay angle and the second lay angle is greater than 0° and no greater than about 4°. In one particular embodiment, the method further comprises stranding a plurality of ductile metal wires around the thermoplastic polymer composite wires.

Exemplary embodiments of stranded thermoplastic polymer composite cables according to the present disclosure have various features and characteristics that enable their use and provide advantages in a variety of applications. For example, in some exemplary embodiments, stranded thermoplastic polymer composite cables according to the present disclosure may exhibit a reduced tendency to undergo premature fracture or failure at lower values of cable tensile strain during manufacture or use, when compared to other composite cables. In addition, stranded thermoplastic polymer composite cables according to some exemplary embodiments may exhibit improved corrosion resistance, environmental endurance (e.g., UV and moisture resistance), resistance to loss of strength at elevated temperatures, creep resistance, as well as relatively high elastic modulus, low density, low coefficient of thermal expansion, high electrical conductivity, high sag resistance, and high strength, when compared to conventional stranded ductile metal wire cables.

In some exemplary embodiments, helically stranded thermoplastic polymer composite cables made according to embodiments of the present disclosure may exhibit an increase in tensile strength of 10% or greater compared to prior art composite cables. Helically stranded thermoplastic polymer composite cables according to certain embodiments of the present disclosure may also be made at a lower manufacturing cost due to an increase in yield from the stranding process of cable meeting the minimum tensile strength requirements for use in certain critical applications, for example, use in electrical power transmission applications. In certain presently preferred exemplary embodiments, exemplary helically stranded thermoplastic polymer composite cables according to the present disclosure may be used as overhead electrical power transmission cables, underground electrical power transmission cables, and underwater electrical power transmission cables, including underwater tethers or underwater umbilicals.

In some exemplary embodiments, helically stranded thermoplastic polymer composite cables made according to embodiments of the present disclosure may be advantageously stranded with lay lengths that are much shorter than previously possible without observing a substantial decrease in cable strength, as is commonly observed using conventional elastically stranded composite wires. Such conventional elastically stranded composite wire cables exhibit a strength reduction generally proportional to the ratio of the wire radius to the bend radius of the stranded composite wire. The loss of strength due to bending strain is thus proportional to the ratio of the bending strain to the strain to failure of the composite material. Because the bending strain is inversely proportional to the lay length, as the lay length is made shorter, the bending strain in the conventional elastically stranded composite wire cable increases, thereby reducing cable strength.

Typically elastically stranded wires cannot have a lay lengths less than about 1000 times the wire radius which equates to a 0.05% bending strain in the wire. Typical composite materials used in the composite wires have strains to failures of between 0.5% to 2%, which equates to a strength reduction from stranding of 20% for a wire with 0.5% strain to failure, and a 5% strength reduction in a wire with a 2% strain to failure. However, some exemplary embodiments of stranded composite cables according to the present disclosure can be stranded with much lower lay angles more typical of non-composite cables constructed of plastically deformed ductile (e.g. metal) wires. Such short lay lengths of cables comprising elastically stranded composite wires have been previously unobtainable in the art, because the bending strain would exceed the strain to failure of the composite material, thereby preventing stranding of the polymer composite wires without breakage of the wires. Thermoplastic polymer composite cables with shorter lay lengths, and/or alternate lay angles between layers, may be preferred for maintaining cable integrity, torsional balance in the cable, and improved flexibility.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF DRAWINGS

Exemplary embodiments of the present disclosure are further described with reference to the appended figures, wherein:

FIG. 1A is a perspective view of a helically stranded thermoplastic polymer composite cable according to certain exemplary embodiments of the present disclosure.

FIG. 1B is a perspective view of a helically stranded thermoplastic polymer composite cable according to certain alternative exemplary embodiments the present disclosure.

FIGS. 2A-2F are cross-sectional end views of various helically stranded thermoplastic polymer composite cables according to exemplary embodiments of the present disclosure.

FIG. 3 is a schematic view of an exemplary stranding apparatus used to make cable in accordance with additional exemplary embodiments of the present disclosure.

Like reference numerals in the drawings indicate like elements. The drawings herein as not to scale, and in the drawings, the components of the thermoplastic polymer composite cables are sized to emphasize selected features.

### DETAILED DESCRIPTION

Certain terms are used throughout the description and the claims that, while for the most part are well known, may require some explanation. It should understood that, as used herein, when referring to a “wire” as being “brittle,” this means that the wire will fracture under tensile loading with minimal plastic deformation.

The term “ductile” when used to refer to the deformation of a wire, means that the wire would substantially undergo plastic deformation during bending without fracture or breakage.

The term “(co)polymer” means a homopolymer or a copolymer.

The term “(meth)acrylate” means an acrylate or a methacrylate.

The term “composite wire” refers to a wire formed from a combination of materials differing in composition or form which are bound together.

The term “polymer composite wire” refers to a composite wire comprising one or more reinforcing materials bound into a matrix including one or more polymeric phases, which may comprise thermosetting polymers or thermoplastic polymers.

The term “thermoplastic polymer composite wire” refers to a composite wire comprising one or more reinforcing fiber materials bound into a matrix including one or more thermoplastic polymeric phases, and which may exhibit ductile behavior when heated to a temperature sufficient to soften the thermoplastic polymer phase.

The term “ceramic-polymer composite wire” refers to a composite wire comprising one or more reinforcing ceramic fiber materials bound into a matrix including one or more polymeric phases.

The term “metal matrix composite wire” refers to a composite wire comprising one or more reinforcing materials bound into a matrix including one or more metal phases, and which exhibits non-ductile behavior and is brittle.

The term “bend” or “bending” when used to refer to the deformation of a wire includes two dimensional and/or three dimensional bend deformation, such as helically bending the wire during stranding. When referring to a wire as having bend deformation, this does not exclude the possibility that the wire also has deformation resulting from tensile and/or torsional forces.

“Significant elastic bend” deformation means bend deformation which occurs when the wire is bent to a radius of curvature up to 10,000 times the radius of the wire. As applied to a circular cross section wire, this significant elastic bend deformation would impart a strain at the outer fiber of the wire of at least 0.01%.

The terms “cabling” and “stranding” are used interchangeably, as are “cabled” and “stranded.”

The term “lay” describes the manner in which the wires in a stranded layer of a helically stranded cable are wound into a helix.

The term “lay direction” refers to the stranding direction of the wire strands in a helically stranded layer. To determine the lay direction of a helically stranded layer, a viewer looks at the surface of the helically stranded wire layer as the cable points away from the viewer. If the wire strands appear to turn in a clockwise direction as the strands progress away from the viewer, then the cable is referred to as having a “right hand lay.” If the wire strands appear to turn in a counter-clockwise direction as the strands progress away from the viewer, then the cable is referred to as having a “left hand lay.”

The terms “center axis” and “center longitudinal axis” are used interchangeably to denote a common longitudinal axis positioned radially at the center of a multilayer helically stranded cable.

The term “lay angle” refers to the angle, formed by a stranded wire, relative to the center longitudinal axis of a helically stranded cable.

The term “crossing angle” means the relative (absolute) difference between the lay angles of adjacent wire layers of a helically stranded wire cable.

The term “lay length” refers to the length of the stranded cable in which a single wire in a helically stranded layer completes one full helical revolution about the center longitudinal axis of a helically stranded cable.

The term “ceramic” means glass, crystalline ceramic, glass-ceramic, and combinations thereof.

The term “polycrystalline” means a material having predominantly a plurality of crystalline grains in which the grain size is less than the diameter of the fiber in which the grains are present.

The term “continuous fiber” means a fiber having a length that is relatively infinite when compared to the average fiber diameter. Typically, this means that the fiber has an aspect ratio (i.e., ratio of the length of the fiber to the average diameter of the fiber) of at least 1×10⁵ (in some embodiments, at least 1×10⁶, or even at least 1×10⁷). Typically, such fibers have a length on the order of at least about 15 cm to at least several meters, and may even have lengths on the order of kilometers or more.

In some applications, it is desirable to further improve the construction of stranded composite cables and their method of manufacture. In certain applications, it is desirable to improve the physical properties of helically stranded composite cables, for example, their tensile strength and elongation to failure of the cable. In some particular applications, it is further desirable to provide a convenient means to maintain the helical arrangement of the stranded composite wires prior to incorporating them into a subsequent article such as an electrical power transmission cable. Such a means for maintaining the helical stranding arrangement has not been necessary in prior stranded cables made using plastically deformable ductile metal wires, or with composite wires that can be held in the stranded configuration using a maintaining means, for example, by curing or the polymer matrix, or by wrapping the stranded composite wires with an adhesive tape, so as to maintain the helical arrangement of the wires after stranding.

Thus, some exemplary embodiments of the present disclosure are directed to thermoplastic polymer composite wires including a thermoplastic polymer matrix which may maintain the helical arrangement of the thermoplastic polymer composite wires after stranding without use of a maintaining means as described above. Other embodiments of the present disclosure are directed at stranded thermoplastic polymer composite cables and methods of helically stranding thermoplastic polymer composite wire layers in a common lay direction that result in a surprising increase in tensile strength of the polymer composite cable when compared to conventional composite cables helically stranded using alternate lay directions between each polymer composite wire layer. Such a surprising increase in tensile strength has not been observed for conventional ductile (e.g. metal, or other non-polymer composite) wires when stranded using a common lay direction. Furthermore, there is typically a low motivation to use a common lay direction for the stranded wire layers of a conventional ductile wire cable, because the ductile metal wires may be readily plastically deformed, and such cables generally use shorter lay lengths, for which alternating lay directions may be preferred for maintaining cable integrity.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

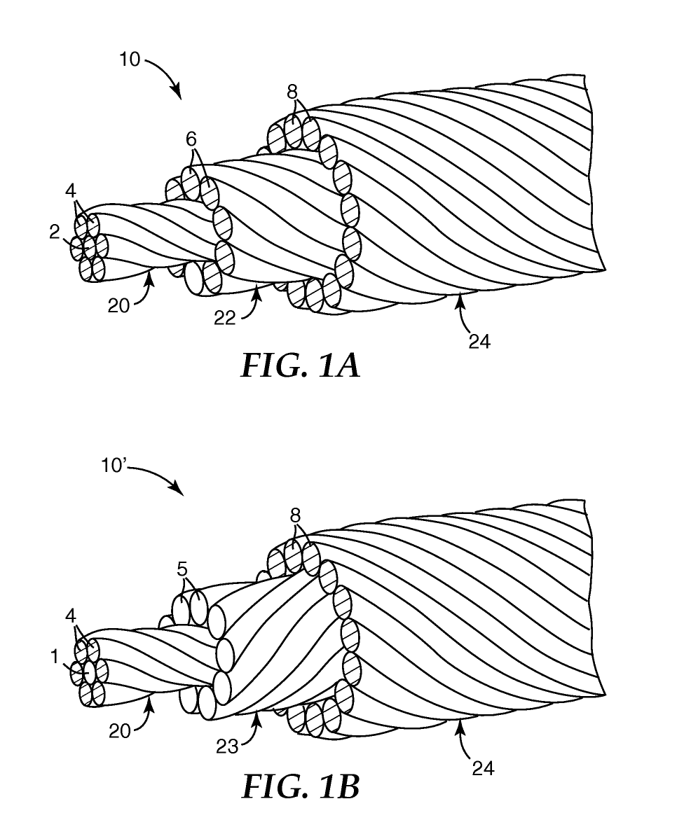

Thus in one aspect, the present disclosure provides a helically stranded thermoplastic polymer composite cable. Referring to the drawings, FIG. 1A illustrates a perspective view of a helically stranded thermoplastic polymer composite cable 10 according to one exemplary embodiment of the present disclosure. As illustrated, the helically stranded polymer composite cable 10 includes a single wire 2 defining a center longitudinal axis, a first layer 20 comprising a first plurality of thermoplastic polymer composite wires 4 stranded around the single wire 2 in a first lay direction (clockwise is shown, corresponding to a right hand lay), and a second layer 22 comprising a second plurality of thermoplastic polymer composite wires 6 stranded around the first plurality of thermoplastic polymer composite wires 4 in the first lay direction.

As illustrated by FIG. 1A, optionally, a third layer 24 comprising a third plurality of thermoplastic polymer composite wires 8 may be stranded around the second plurality of thermoplastic polymer composite wires 6 in the first lay direction to form polymer composite cable 10. In other exemplary embodiments, an optional fourth layer (not shown) or even more additional layers of polymer composite wires may be stranded around the second plurality of thermoplastic polymer composite wires 6 in the first lay direction.

Optionally, the single wire 2 is a thermoplastic polymer composite wire, although in other embodiments, the single wire 2 may be a non-thermoplastic wire, such as a metal wire, or a non-thermoplastic composite wire, such as, for example, a thermosetting polymer composite wire or a metal matrix composite wire.

In exemplary presently preferred embodiments of the disclosure, two or more stranded layers (e.g. 20, 22, 24, and the like) of thermoplastic polymer composite wires (e.g. 4, 6, 8, and the like) may be helically wound about the single center wire 2 defining a center longitudinal axis, such that each successive layer of thermoplastic polymer composite wires is wound in the same lay direction as each preceding layer of wires. Furthermore, it will be understood that while a right hand lay is illustrated in FIG. 1A for each layer (20, 22, and 24), a left hand lay may alternatively be used for each layer (20, 23, 24, and the like), as shown for the exemplary helically stranded thermoplastic polymer composite cable illustrated by FIG. 1B.

Thus, FIG. 1B illustrates a perspective view of a helically stranded thermoplastic polymer composite cable 10′ according to one alternative exemplary embodiment of the present disclosure. As illustrated, the helically stranded polymer composite cable 10′ includes a single wire 1 (which may, for example, be a thermoplastic polymer composite wire or a non-thermoplastic wires comprising, for example, metal wires, thermosetting polymer composite wires, or metal matrix composite wires) defining a center longitudinal axis, a first layer 20 comprising a first plurality of thermoplastic polymer composite wires 4 stranded around the single wire 1 in a first lay direction (counter-clockwise is shown, corresponding to a left hand lay), a second layer 23 comprising a second plurality of non-thermoplastic polymer composite wires 5 (which may, for example, be metal wires, thermosetting polymer composite wires, or metal matrix composite wires) stranded around the first plurality of thermoplastic polymer composite wires 4 in a second lay direction opposite the first lay direction, and a third layer 24 comprising a third plurality of thermoplastic polymer composite wires 8 stranded around the second plurality of non-thermoplastic wires 5 in the first lay direction to form polymer composite cable 10′.

In other exemplary embodiments, an optional fourth layer (not shown) may be stranded around the second plurality of non-thermoplastic polymer composite wires 5 in the second lay direction. In exemplary presently preferred embodiments of the disclosure, two or more alternating stranded layers of thermoplastic polymer composite wires (e.g. 4 and 8) and non-thermoplastic wires (e.g. 5) may be helically wound about the single center wire 1 defining a center longitudinal axis, such that each successive layer of thermoplastic polymer composite wires is wound in the same lay direction as each preceding layer of wires, as shown in FIG. 1A. Furthermore, it will be understood that while a left hand lay is illustrated in FIG. 1B for layer 5, and a right hand lay is illustrated for layers 4 and 8, a right hand lay may alternatively be used for layer 5, and a left hand lay may alternatively be used for layers 15, 16, and the like.

Optionally, in any of the foregoing embodiments, the single wire 2 may be a thermoplastic polymer composite wire, although in other embodiments, the single wire 2 may be a non-thermoplastic wire, such as a metal wire, or a non-thermoplastic composite wire, such as, for example, a thermosetting polymer composite wire or a metal matrix composite wire.

In the foregoing exemplary embodiments, the first lay direction is preferably the same as the second lay direction, the third lay direction is preferably the same as the second lay direction, the fourth lay direction may the same as the third lay direction, and in general, any outer layer lay direction is preferably the same as the adjacent inner layer lay direction. However, in other exemplary embodiments, the first lay direction may be opposite the second lay direction, the third lay direction may be opposite the second lay direction, the fourth lay direction may be opposite the third lay direction, and in general, any outer layer lay direction may be opposite the adjacent inner layer lay direction.

In certain presently preferred embodiments of any of the foregoing exemplary embodiments, the relative difference between the first lay angle and the second lay angle is preferably greater than 0° and no greater than about 4°, the relative difference between the third lay angle and the second lay angle is preferably greater than 0° and no greater than about 4°, the relative difference between the fourth lay angle and the third lay angle is preferably greater than 0° and no greater than about 4°, and in general, any inner layer lay angle and the adjacent outer layer lay angle, is preferably greater than 0° and no greater than about 4°, more preferably no greater than 3°, most preferably no greater than 0.5°.

In further presently preferred exemplary embodiments, one or more of the first lay length is preferably less than or equal to the second lay length, the second lay length is preferably less than or equal to the third lay length, the fourth lay length is preferably less than or equal to an immediately subsequent lay length, and/or each succeeding lay length is preferably less than or equal to the immediately preceding lay length. In other embodiments, one or more of the first lay length equals the second lay length, the second lay length equals the third lay length, and the third lay length equals the fourth lay length. In some exemplary embodiments, it may be preferred to use a parallel lay, as is known in the art.

In further exemplary embodiments (not shown in the figures), the helically stranded thermoplastic polymer composite cable may further comprise additional (e.g. subsequent) layers (e.g. a fourth, fifth, or additional subsequent layers) of thermoplastic polymer composite wires helically stranded around the third plurality of thermoplastic polymer composite wires 8 in the first lay direction at a lay angle (not shown in the figures) defined relative to the common longitudinal axis, wherein the polymer composite wires in each layer have a characteristic lay length (not shown in the figures), the relative difference between the third lay angle and the fourth or subsequent lay angle being greater than 0° and no greater than about 4°. Embodiments in which four or more layers of stranded polymer composite wires are employed preferably make use of polymer composite wires having a diameter of 0.5 mm or less.

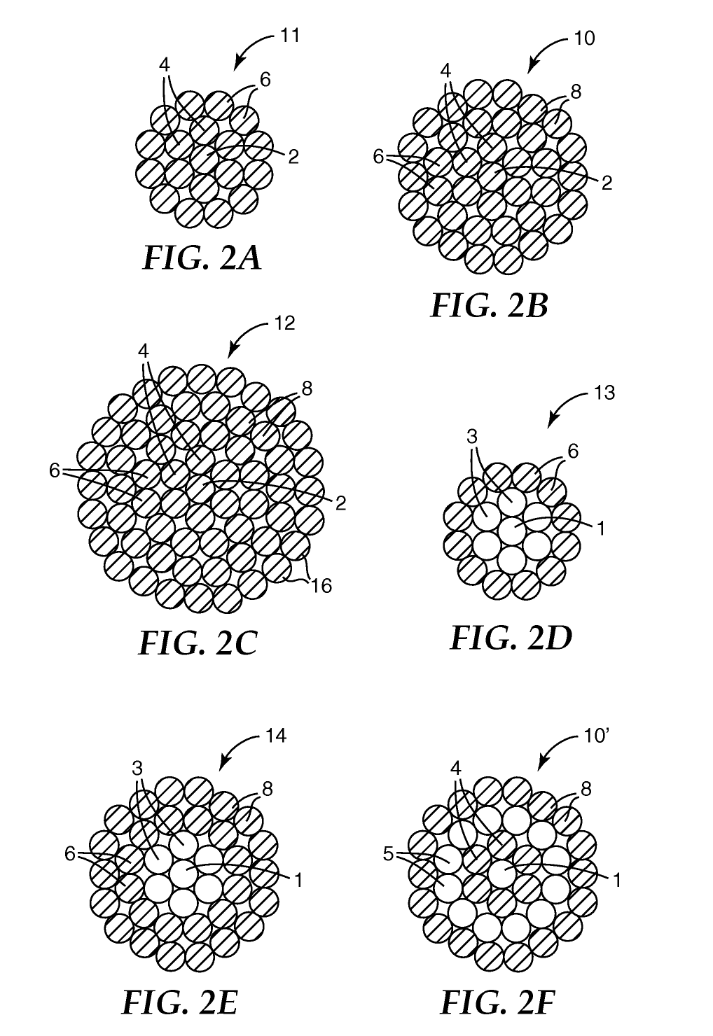

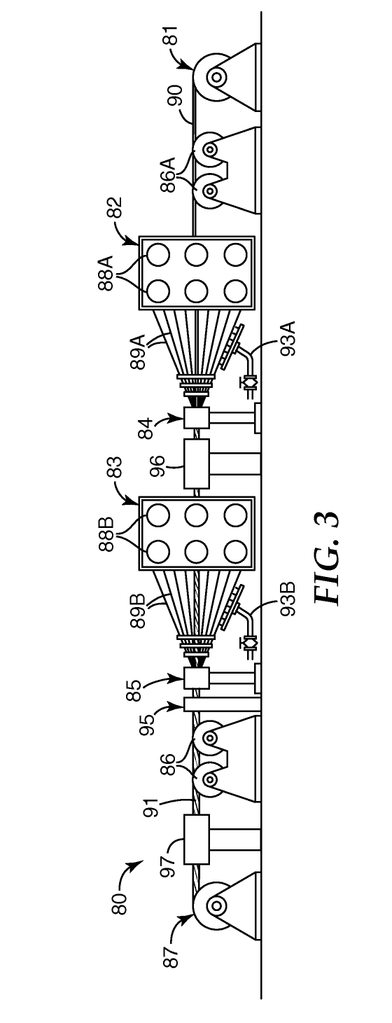

Various configurations of helically stranded thermoplastic polymer composite cables are illustrated by cross-sectional views in FIGS. 2A-2F. These exemplary embodiments are intended to be illustrative only; additional configurations are within the scope of this disclosure. In each of the illustrated embodiments of FIGS. 2A-2F, it is understood that the thermoplastic polymer composite wires (e.g. 4, 6, and 8) are stranded about a single wire (2 in FIGS. 2A and 3C; 1 in FIGS. 3B and 3D) defining a center longitudinal axis (not shown), in a lay direction (not shown). Such lay direction may be clockwise (right hand lay) or counter-clockwise (left hand lay). Furthermore, such lay direction may be the same for each succeeding layer of stranded wires, as shown in FIGS. 1A-1B, or may alternate to the opposite lay direction in each succeeding layer of stranded wires (not shown in the figures). It is further understood that each layer of thermoplastic polymer composite wires exhibits a lay length (not shown in FIGS. 2A-2F), and that the lay length of each layer of wires may be different, or preferably, the same lay length.

FIG. 2A illustrates a cross-sectional view of an exemplary helically stranded thermoplastic polymer composite cable 11 comprising a single wire 2 (shown as a thermoplastic polymer composite wire, but which alternatively may be a non-thermoplastic composite wire, for example, a thermosetting polymer composite wire or a metal matrix composite wire, or a metal wire) defining a center longitudinal axis, a plurality of thermoplastic polymer composite wires 4 helically stranded around the single wire 2, and a second plurality of thermoplastic polymer composite wires 6 helically stranded around the first plurality of thermoplastic polymer composite wires 4.

FIG. 2B illustrates a cross-sectional view of another exemplary helically stranded thermoplastic polymer composite cable 10 as shown in FIG. 1A, the cable comprising a single wire 2 (shown as a thermoplastic polymer composite wire, but which alternatively may be a non-thermoplastic composite wire, for example, a thermosetting polymer composite wire or a metal matrix composite wire) defining a center longitudinal axis, a first plurality of thermoplastic polymer composite wires 4 helically stranded around the single wire 2, a second plurality of thermoplastic polymer composite wires 6 helically stranded around the first plurality of thermoplastic polymer composite wires 4, and a third plurality of thermoplastic polymer composite wires 8 helically stranded around the second plurality of thermoplastic polymer composite wires 6.

FIG. 2C illustrates a cross-sectional view of an additional exemplary helically stranded thermoplastic polymer composite cable 12 including a single wire 2 (shown as a thermoplastic polymer composite wire, but which alternatively may be a non-thermoplastic composite wire, for example, a thermosetting polymer composite wire or a metal matrix composite wire) defining a center longitudinal axis, a first plurality of thermoplastic polymer composite wires 4 helically stranded around the single wire 2, a second plurality of thermoplastic polymer composite wires 6 helically stranded around the first plurality of thermoplastic polymer composite wires 4, a third plurality of thermoplastic polymer composite wires 8 helically stranded around the second plurality of thermoplastic polymer composite wires 6, and a fourth plurality of thermoplastic polymer composite wires 16 helically stranded around the third plurality of thermoplastic polymer composite wires 8.

FIG. 2D illustrates a cross-sectional view of an exemplary alternative configuration of a helically stranded thermoplastic polymer composite cable 13 including a single non-thermoplastic wire 1 (shown as a metal wire, but which alternatively may be a non-thermoplastic composite wire, for example, a thermosetting polymer composite wire or a metal matrix composite wire) defining a center longitudinal axis, a first plurality of non-thermoplastic wires 3 (comprising, for example, metal wires, thermosetting polymer composite wires, or metal matrix composite wires) helically stranded around the single non-thermoplastic wire 1, and a second plurality of thermoplastic polymer composite wires 6 helically stranded around the first plurality of non-thermoplastic wires 3.

FIG. 2E illustrates a cross-sectional view of another exemplary alternative configuration of a helically stranded thermoplastic polymer composite cable 14 including a single non-thermoplastic wire 1 (shown as a metal wire, but which alternatively may be a non-thermoplastic composite wire, for example, a thermosetting polymer composite wire or a metal matrix composite wire) defining a center longitudinal axis, a first plurality of non-thermoplastic wires 3 (comprising, for example, metal wires, thermosetting polymer composite wires, or metal matrix composite wires) helically stranded around the single wire 2, a second plurality of thermoplastic polymer composite wires 6 helically stranded around the first plurality of non-thermoplastic wires 3, and a third plurality of thermoplastic polymer composite wires 8 helically stranded around the second plurality of non-thermoplastic wires 6.

FIG. 2F illustrates a cross-sectional view of another exemplary alternative configuration of a helically stranded thermoplastic polymer composite cable 10′ as shown in FIG. 1B, comprising a single non-thermoplastic wire 1 (shown as a metal wire, but which alternatively may be a non-thermoplastic composite wire, for example, a thermosetting polymer composite wire or a metal matrix composite wire) defining a center longitudinal axis, a first plurality of thermoplastic polymer composite wires 4 helically stranded around the single wire 2, a second plurality of non-thermoplastic wires 5 (comprising, for example, metal wires, thermosetting polymer composite wires, or metal matrix composite wires) helically stranded around the first plurality of thermoplastic polymer composite wires 4, and a third plurality of thermoplastic polymer composite wires 8 helically stranded around the second plurality of non-thermoplastic wires 5.

Although FIGS. 2A-2C each show a single center thermoplastic polymer composite wire 2 defining a center longitudinal axis (not shown), it is additionally understood that single wire 2 may be a non-thermoplastic wire, such as a composite wire (e.g. a thermosetting polymer composite wire, or a metal matrix composite wire, or a metal wire, or a ductile metal wire 1 (as shown in FIGS. 2D-2F).

Furthermore, it is understood that in any of the foregoing embodiments, each of the thermoplastic polymer composite wires may have a cross-sectional shape, in a direction substantially normal to the center longitudinal axis, generally circular, elliptical, or trapezoidal. In certain exemplary embodiments, each of the thermoplastic polymer composite wires has a cross-sectional shape that is generally circular, and the diameter of each polymer composite wire is at least about 0.1 mm, more preferably at least 0.5 mm; yet more preferably at least 1 mm, still more preferably at least 2 mm, most preferably at least 3 mm; and at most about 15 mm, more preferably at most 10 mm, still more preferably at most 5 mm, even more preferably at most 4 mm, most preferably at most 3 mm. In other exemplary embodiments, the diameter of each thermoplastic polymer composite wire may be less than 1 mm, or greater than 5 mm.

Typically the average diameter of the single center wire, having a generally circular cross-sectional shape, is in a range from about 0.1 mm to about 15 mm. In some embodiments, the average diameter of the single center wire is desirably is at least about 0.1 mm, at least 0.5 mm, at least 1 mm, at least 2 mm, at least 3 mm, at least 4 mm, or even up to about 5 mm. In other embodiments, the average diameter of the single central wire is less than about 0.5 mm, less than 1 mm, less than 3 mm, less than 5 mm, less than 10 mm, or less than 15 mm.

In additional exemplary embodiments not illustrated by FIGS. 2A-2F, the helically stranded thermoplastic polymer composite cable may include more than three stranded layers of thermoplastic polymer composite wires about the single wire defining a center longitudinal axis. In certain exemplary embodiments, each of the thermoplastic polymer composite wires in each layer of the helically stranded thermoplastic polymer composite cable may be of the same construction and shape; however this is not required in order to achieve the benefits described herein.

In certain exemplary embodiments, the helically stranded thermoplastic polymer composite wires (e.g. 2, 4, 6, 8, and the like) each comprise a plurality of continuous fibers in a thermoplastic polymer matrix as will be discussed in more detail later. Because the wires are thermoplastic polymer composites, they may be plastically deformed when heated during (or subsequent to) the cabling operation, unlike conventional metal matrix or ceramic matrix composite wires. Thus, for example, a conventional cabling process could be carried out so as to permanently plastically deform the polymer composite wires in their helical arrangement, eliminating the need for a retaining means for maintaining the helically stranded configuration of the helically stranded thermoplastic polymer composite wires.

The present disclosure's use of thermoplastic polymer composite wires to form a helically stranded cable may thus provide superior desired characteristics compared to conventional non-thermoplastic polymer composite wires. The use of thermoplastic polymer composite wires allows the helically stranded thermoplastic polymer composite cable to be conveniently handled as a final cable article, or to be conveniently handled as an intermediate cable article before being incorporated into a subsequent final cable article.

In exemplary embodiments, the thermoplastic polymer composite wires comprise at least one continuous fiber in a thermoplastic polymer matrix. In some exemplary embodiments, the at least one continuous fiber comprises a metal, a polymer, ceramic, glass, carbon, and combinations thereof. In certain presently preferred embodiments, the at least one continuous fiber comprises titanium, tungsten, boron, shape memory alloy, carbon nanotubes, graphite, silicon carbide, boron, aramid, poly(p-phenylene-2,6-benzobisoxazole), and combinations thereof.

In additional exemplary embodiments, the polymer matrix of a polymer composite wire comprises a (co)polymer selected from an epoxy, an ester, a vinyl ester, a polyimide, a polyester, a cyanate ester, a phenolic resin, a bis-maleimide resin, and combinations thereof. In certain presently preferred embodiments, the polymer matrix of the thermoplastic polymer composite wire comprises a thermoplastic (co)polymer selected from a (meth)acrylate, a vinyl ester, a polyester, a cyanate ester, polyetherether ketone (PEEK), and combinations thereof. A high temperature thermoplastic (co)polymer may be preferred. A presently preferred high temperature thermoplastic (co)polymer is PEEK.

In some exemplary embodiments, the polymer matrix may additionally comprise one or more thermoplastic fluoropolymers. Suitable thermoplastic fluoropolymers include fluorinated ethylenepropylene copolymer (FEP), polytetrafluoroethylene (PTFE), ethylenetetrafluorethylene (ETFE), ethylenechlorotrifluoroethylene (ECTFE), polyvinylidene fluoride (PVDF), polyvinyl fluoride (PVF), tetrafluoroethylene polymer (TFV). Particularly suitable fluoropolymers are those sold under the trade names DYNEON THV FLUOROPLASTICS, DYNEON ETFE FLUOROPLASTICS, DYNEON FEP FLUOROPLASTICS, DYNEON PFA FLUOROPLASTICS, and DYNEON PVDF FLUOROPLASTICS (all available from 3M Company, St. Paul, Minn.).

While the present disclosure may be practiced with any suitable thermoplastic polymer composite wire, in certain exemplary embodiments, each of the thermoplastic polymer composite wires is selected to be a fiber reinforced thermoplastic polymer composite wire comprising at least one of a continuous fiber tow, or a continuous monofilament fiber, in a thermoplastic polymer matrix. In some embodiments, at least 85% (in some embodiments, at least 90%, or even at least 95%) by number of the fibers in the thermoplastic polymer composite wires are continuous. In some presently preferred embodiments, the thermoplastic polymer composite wires preferably have a tensile strain to failure of at least 0.4%, more preferably at least 0.7%.

Additionally, at least the single wire 2 may be a thermosetting polymer composite wire. Suitable thermosetting polymer composite wires are disclosed, for example, in U.S. Pat. Nos. 6,180,232; 6,245,425; 6,329,056; 6,336,495; 6,344,270; 6,447,927; 6,460,597; 6,544,645; 6,559,385, 6,723,451; and 7,093,416.

A presently preferred embodiment for the thermoplastic polymer composite wires comprises a plurality of continuous ceramic fibers in a thermoplastic polymer matrix. Other fibers that could be used with the present disclosure include glass fibers, silicon carbide fibers, carbon fibers, and combinations of such polymer composite wires. Examples of suitable ceramic fibers include metal oxide (e.g., alumina) fibers, boron nitride fibers, silicon carbide fibers, and combination of any of these fibers. Typically, the ceramic oxide fibers are crystalline ceramics and/or a mixture of crystalline ceramic and glass (i.e., a fiber may contain both crystalline ceramic and glass phases). Typically, such fibers have a length on the order of at least 50 meters, and may even have lengths on the order of kilometers or more. Typically, the continuous ceramic fibers have an average fiber diameter in a range from about 5 micrometers to about 50 micrometers, about 5 micrometers to about 25 micrometers about 8 micrometers to about 25 micrometers, or even about 8 micrometers to about 20 micrometers. In some embodiments, the crystalline ceramic fibers have an average tensile strength of at least 1.4 GPa, at least 1.7 GPa, at least 2.1 GPa, and or even at least 2.8 GPa. In some embodiments, the crystalline ceramic fibers have a modulus greater than 70 GPa to approximately no greater than 1000 GPa, or even no greater than 420 GPa.

Examples of suitable ceramic fibers include silicon carbide fibers. Typically, the silicon carbide monofilament fibers are crystalline and/or a mixture of crystalline ceramic and glass (i.e., a fiber may contain both crystalline ceramic and glass phases). Typically, such fibers have a length on the order of at least 50 meters, and may even have lengths on the order of kilometers or more. Typically, the continuous silicon carbide monofilament fibers have an average fiber diameter in a range from about 100 micrometers to about 250 micrometers. In some embodiments, the crystalline ceramic fibers have an average tensile strength of at least 2.8 GPa, at least 3.5 GPa, at least 4.2 GPa and or even at least 6 GPa. In some embodiments, the crystalline ceramic fibers have a modulus greater than 250 GPa to approximately no greater than 500 GPa, or even no greater than 430 GPa.

One presently preferred ceramic fiber comprises polycrystalline α-Al₂O₃. Suitable alumina fibers are described, for example, in U.S. Pat. Nos. 4,954,462 (Wood et al.) and 5,185,299 (Wood et al.). Exemplary alpha alumina fibers are marketed under the trade designation “NEXTEL 610” (3M Company, St. Paul, Minn.). In some embodiments, the alumina fibers are polycrystalline alpha alumina fibers and comprise, on a theoretical oxide basis, greater than 99 percent by weight Al₂O₃ and 0.2-0.5 percent by weight SiO₂, based on the total weight of the alumina fibers. In another aspect, some desirable polycrystalline, alpha alumina fibers comprise alpha alumina having an average grain size of less than one micrometer (or even, in some embodiments, less than 0.5 micrometer). In another aspect, in some embodiments, polycrystalline, alpha alumina fibers have an average tensile strength of at least 1.6 GPa (in some embodiments, at least 2.1 GPa, or even, at least 2.8 GPa).

Suitable aluminosilicate fibers are described, for example, in U.S. Pat. No. 4,047,965 (Karst et al). Exemplary aluminosilicate fibers are marketed under the trade designations “NEXTEL 440”, “NEXTEL 550”, and “NEXTEL 720” by 3M Company of St. Paul, Minn. Aluminoborosilicate fibers are described, for example, in U.S. Pat. No. 3,795,524 (Sowman). Exemplary aluminoborosilicate fibers are marketed under the trade designation “NEXTEL 312” by 3M Company. Boron nitride fibers can be made, for example, as described in U.S. Pat. Nos. 3,429,722 (Economy) and 5,780,154 (Okano et al.). Exemplary silicon carbide fibers are marketed, for example, by COI Ceramics of San Diego, Calif. under the trade designation “NICALON” in tows of 500 fibers, from Ube Industries of Japan, under the trade designation “TYRANNO”, and from Dow Corning of Midland, Mich. under the trade designation “SYLRAMIC”.

Examples of suitable glass fibers include A-Glass, B-Glass, C-Glass, D-Glass, S-Glass, AR-Glass, R-Glass, fiberglass and paraglass, as known in the art. Other glass fibers may also be used; this list is not limited, and there are many different types of glass fibers commercially available, for example, from Corning Glass Company (Corning, N.Y.).

In some exemplary embodiments, continuous glass fibers may be preferred. Typically, the continuous glass fibers have an average fiber diameter in a range from about 3 micrometers to about 19 micrometers. In some embodiments, the glass fibers have an average tensile strength of at least 3 GPa, 4 GPa, and or even at least 5 GPa. In some embodiments, the glass fibers have a modulus in a range from about 60 GPa to 95 GPa, or about 60 GPa to about 90 GPa.

Suitable carbon fibers include commercially available carbon fibers such as the fibers designated as PANEX® and PYRON® (available from ZOLTEK, Bridgeton, Mo.), THORNEL (available from CYTEC Industries, Inc., West Paterson, N.J.), HEXTOW (available from HEXCEL, Inc., Southbury, Conn.), and TORAYCA (available from TORAY Industries, Ltd. Tokyo, Japan). Such carbon fibers may be derived from a polyacrylonitrile (PAN) precursor. Other suitable carbon fibers include PAN-IM, PAN-HM, PAN UHM, PITCH or rayon byproducts, as known in the art.

Additional suitable commercially available fibers include ALTEX (available from Sumitomo Chemical Company, Osaka, Japan), and ALCEN (available from Nitivy Company, Ltd., Tokyo, Japan). Suitable fibers also include shape memory alloy (i.e., a metal alloy that undergoes a Martensitic transformation such that the metal alloy is deformable by a twinning mechanism below the transformation temperature, wherein such deformation is reversible when the twin structure reverts to the original phase upon heating above the transformation temperature). Commercially available shape memory alloy fibers are available, for example, from Johnson Matthey Company (West Whiteland, Pa.).

In some embodiments the ceramic fibers are in tows. Tows are known in the fiber art and refer to a plurality of (individual) fibers (typically at least 100 fibers, more typically at least 400 fibers) collected in a roving-like form. In some embodiments, tows comprise at least 780 individual fibers per tow, in some cases at least 2600 individual fibers per tow, and in other cases at least 5200 individual fibers per tow. Tows of ceramic fibers are generally available in a variety of lengths, including 300 meters, 500 meters, 750 meters, 1000 meters, 1500 meters, 2500 meters, 5000 meters, 7500 meters, and longer. The fibers may have a cross-sectional shape that is circular or elliptical.

Commercially available fibers may typically include an organic sizing material added to the fiber during manufacture to provide lubricity and to protect the fiber strands during handling. The sizing may be removed, for example, by dissolving or burning the sizing away from the fibers. Typically, it is desirable to remove the sizing before forming metal matrix polymer composite wire. The fibers may also have coatings used, for example, to enhance the wettability of the fibers, to reduce or prevent reaction between the fibers and molten metal matrix material. Such coatings and techniques for providing such coatings are known in the fiber and polymer composite art.

Presently preferred thermoplastic polymer composite wires according to the present disclosure may have a fiber density of between about 3.90-3.95 grams per cubic centimeter. Among the preferred fibers are those described in U.S. Pat. No. 4,954,462 (Wood et al.). Preferred fibers are available commercially under the trade designation “NEXTEL 610” alpha alumina based fibers (available from 3M Company, St. Paul, Minn.). The thermoplastic polymer matrix is preferably selected such that it does not significantly react chemically with the fiber material (i.e., is relatively chemically inert with respect the fiber material), thereby eliminating the need to provide a protective coating on the fiber exterior.

In further exemplary embodiments, the helically stranded thermoplastic polymer composite cable may additionally include one or more fiber reinforced metal matrix composite wires. One presently preferred fiber reinforced metal matrix composite wire is a ceramic fiber reinforced aluminum matrix composite wire. The ceramic fiber reinforced aluminum matrix composite wires preferably comprise continuous fibers of polycrystalline α-Al₂O₃ encapsulated within a matrix of either substantially pure elemental aluminum or an alloy of pure aluminum with up to about 2% by weight copper, based on the total weight of the matrix. The preferred fibers comprise equiaxed grains of less than about 100 nm in size, and a fiber diameter in the range of about 1-50 micrometers. A fiber diameter in the range of about 5-25 micrometers is preferred with a range of about 5-15 micrometers being most preferred.

In certain presently preferred embodiments of a fiber reinforced metal matrix composite wire, the use of a matrix comprising either substantially pure elemental aluminum, or an alloy of elemental aluminum with up to about 2% by weight copper, based on the total weight of the matrix, has been shown to produce successful wires. As used herein the terms “substantially pure elemental aluminum”, “pure aluminum” and “elemental aluminum” are interchangeable and are intended to mean aluminum containing less than about 0.05% by weight impurities.

In one presently preferred embodiment, the fiber reinforced metal matrix composite wires comprise between about 30-70% by volume polycrystalline α-Al₂O₃ fibers, based on the total volume of the fiber reinforced metal matrix composite wire, within a substantially elemental aluminum matrix. It is presently preferred that the matrix contains less than about 0.03% by weight iron, and most preferably less than about 0.01% by weight iron, based on the total weight of the matrix. A fiber content of between about 40-60% polycrystalline α-Al₂O₃ fibers is preferred. Such fiber reinforced metal matrix composite wires, formed with a metal matrix having a yield strength of less than about 20 MPa and fibers having a longitudinal tensile strength of at least about 2.8 GPa have been found to have excellent strength characteristics.

The matrix may also be formed from an alloy of elemental aluminum with up to about 2% by weight copper, based on the total weight of the matrix. As in the embodiment in which a substantially pure elemental aluminum matrix is used, fiber reinforced metal matrix composite wires having an aluminum/copper alloy matrix preferably comprise between about 30-70% by volume polycrystalline α-Al₂O₃ fibers, and more preferably therefore about 40-60% by volume polycrystalline α-Al₂O₃ fibers, based on the total volume of the polymer composite. In addition, the matrix preferably contains less than about 0.03% by weight iron, and most preferably less than about 0.01% by weight iron based on the total weight of the matrix. The aluminum/copper matrix preferably has a yield strength of less than about 90 MPa, and, as above, the polycrystalline α-Al₂O₃ fibers have a longitudinal tensile strength of at least about 2.8 GPa.

Fiber reinforced metal matrix composite wires preferably are formed from substantially continuous polycrystalline α-Al₂O₃ fibers contained within the substantially pure elemental aluminum matrix or the matrix formed from the alloy of elemental aluminum and up to about 2% by weight copper described above. Such wires are made generally by a process in which a spool of substantially continuous polycrystalline α-Al₂O₃ fibers, arranged in a fiber tow, is pulled through a bath of molten matrix material. The resulting segment is then solidified, thereby providing fibers encapsulated within the matrix.

Exemplary metal matrix materials include aluminum (e.g., high purity, i.e., greater than 99.95%) elemental aluminum, zinc, tin, magnesium, and alloys thereof (e.g., an alloy of aluminum and copper). Typically, the matrix material is selected such that the matrix material does not significantly chemically react with the fiber (i.e., is relatively chemically inert with respect to fiber material), for example, to eliminate the need to provide a protective coating on the fiber exterior. In some embodiments, the matrix material desirably includes aluminum and alloys thereof.

In some embodiments, the metal matrix comprises at least 98 percent by weight aluminum, at least 99 percent by weight aluminum, greater than 99.9 percent by weight aluminum, or even greater than 99.95 percent by weight aluminum. Exemplary aluminum alloys of aluminum and copper comprise at least 98 percent by weight Al and up to 2 percent by weight Cu. In some embodiments, useful alloys are 1000, 2000, 3000, 4000, 5000, 6000, 7000 and/or 8000 series aluminum alloys (Aluminum Association designations). Although higher purity metals tend to be desirable for making higher tensile strength wires, less pure forms of metals are also useful.

Suitable metals are commercially available. For example, aluminum is available under the trade designation “SUPER PURE ALUMINUM; 99.99% Al” from Alcoa of Pittsburgh, Pa. Aluminum alloys (e.g., Al-2% by weight Cu (0.03% by weight impurities)) can be obtained, for example, from Belmont Metals, New York, N.Y. Zinc and tin are available, for example, from Metal Services, St. Paul, Minn. (“pure zinc”; 99.999% purity and “pure tin”; 99.95% purity). For example, magnesium is available under the trade designation “PURE” from Magnesium Elektron, Manchester, England. Magnesium alloys (e.g., WE43A, EZ33A, AZ81A, and ZE41A) can be obtained, for example, from TIMET, Denver, Colo.

The fiber reinforced metal matrix composite wires typically comprise at least 15 percent by volume (in some embodiments, at least 20, 25, 30, 35, 40, 45, or even 50 percent by volume) of the fibers, based on the total combined volume of the fibers and matrix material. More typically the polymer composite cores and wires comprise in the range from 40 to 75 (in some embodiments, 45 to 70) percent by volume of the fibers, based on the total combined volume of the fibers and matrix material.

Suitable fiber reinforced metal matrix composite wires can be made using techniques known in the art. Continuous metal matrix composite wire can be made, for example, by continuous metal matrix infiltration processes. One suitable process is described, for example, in U.S. Pat. No. 6,485,796 (Carpenter et al.). Thermoplastic polymer composite wires comprising thermoplastic polymers and reinforcing fibers may also be made using pultrusion processes which are known in the art. For example, U.S. Pat. No. 4,680,224 describes “a process for preparing shaped objects of continuous fiber strand material in a poly(arylene sulfide) matrix and the shaped objects prepared thereby. Furthermore, PCT Pat. Pub. No. WO 2005/123999 describes a pultrusion method for producing continuous lengths of fiber reinforced composites having a PEEK matrix: “The shaped objects are prepared by a pultrusion process the method comprising selecting unidirectional and continuous high strength fibers; impregnating the fibers with ultra high molecular weight polyethylene in a fine powder to form a composite; optionally adding additives or fibers to the composite; and forming a continuous matrix of the ultra high molecular weight polyethylene surrounding the fibers.”

Ductile metal wires for stranding around a helically stranded thermoplastic polymer composite core to provide a helically stranded thermoplastic polymer composite cable, e.g. an electrical power transmission cable according to certain embodiments of the present disclosure, are known in the art. Preferred ductile metals include iron, steel, zirconium, copper, tin, cadmium, aluminum, manganese, and zinc; their alloys with other metals and/or silicon; and the like. Copper wires are commercially available, for example from Southwire Company, Carrolton, Ga. Aluminum wires are commercially available, for example from Nexans, Weyburn, Canada or Southwire Company, Carrolton, Ga. under the trade designations “1350-H19 ALUMINUM” and “1350-H0 ALUMINUM”.

Typically, copper wires have a thermal expansion coefficient in a range from about 12 ppm/° C. to about 18 ppm/° C. over at least a temperature range from about 20° C. to about 800° C. Copper alloy (e.g. copper bronzes such as Cu—Si—X, Cu—Al—X, Cu—Sn—X, Cu—Cd; where X═Fe, Mn, Zn, Sn and or Si; commercially available, for example from Southwire Company, Carrolton, Ga.; oxide dispersion strengthened copper available, for example, from OMG Americas Corporation, Research Triangle Park, N.C., under the designation “GLIDCOP”) wires. In some embodiments, copper alloy wires have a thermal expansion coefficient in a range from about 10 ppm/° C. to about 25 ppm/° C. over at least a temperature range from about 20° C. to about 800° C. The wires may be in any of a variety shapes (e.g., circular, elliptical, and trapezoidal).

Typically, aluminum wire have a thermal expansion coefficient in a range from about 20 ppm/° C. to about 25 ppm/° C. over at least a temperature range from about 20° C. to about 500° C. In some embodiments, aluminum wires (e.g., “1350-H19 ALUMINUM”) have a tensile breaking strength, at least 138 MPa (20 ksi), at least 158 MPa (23 ksi), at least 172 MPa (25 ksi) or at least 186 MPa (27 ksi) or at least 200 MPa (29 ksi). In some embodiments, aluminum wires (e.g., “1350-H0 ALUMINUM”) have a tensile breaking strength greater than 41 MPa (6 ksi) to no greater than 97 MPa (14 ksi), or even no greater than 83 MPa (12 ksi).

Aluminum alloy wires are commercially available, for example, aluminum-zirconium alloy wires sold under the trade designations “ZTAL,” “XTAL,” and “KTAL” (available from Sumitomo Electric Industries, Osaka, Japan), or “6201” (available from Southwire Company, Carrolton, Ga.). In some embodiments, aluminum alloy wires have a thermal expansion coefficient in a range from about 20 ppm/° C. to about 25 ppm/° C. over at least a temperature range from about 20° C. to about 500° C.

In further exemplary embodiments, some or all of the ductile metal wires may have a cross-sectional shape, in a direction substantially normal to the center longitudinal axis, that is “Z” or “S” shaped (not shown). Wires of such shapes are known in the art, and may be desirable, for example, to form an interlocking outer layer of the cable.

Exemplary embodiments of the present disclosure preferably provide very long helically stranded thermoplastic polymer composite cables. It is also preferable that the thermoplastic polymer composite wires within the helically stranded thermoplastic polymer composite cable 10 themselves are continuous throughout the length of the stranded cable. In one preferred embodiment, the thermoplastic polymer composite wires are substantially continuous and at least 150 meters long. More preferably, the thermoplastic polymer composite wires are continuous and at least 250 meters long, more preferably at least 500 meters, still more preferably at least 750 meters, and most preferably at least 1000 meters long in the helically stranded thermoplastic polymer composite cable.

In additional exemplary embodiments, the disclosure provides a method of making the helically stranded thermoplastic polymer composite cables as described in any of the foregoing embodiments, the method comprising helically stranding a first plurality of thermoplastic polymer composite wires about a single wire defining a center longitudinal axis, wherein helically stranding the first plurality of thermoplastic polymer composite wires is carried out in a first lay direction at a first lay angle defined relative to the center longitudinal axis, wherein the first plurality of wires have a first lay length; helically stranding a second plurality of thermoplastic polymer composite wires around the first plurality of thermoplastic polymer composite wires, wherein helically stranding the second plurality of thermoplastic polymer composite wires is carried out in the first lay direction at a second lay angle defined relative to the center longitudinal axis, and wherein the second plurality of wires has a second lay length; and heating the helically stranded first and second plurality of thermoplastic polymer composite wires to a temperature and for a time sufficient to retain the helically stranded polymer composite wires in a helically stranded configuration upon cooling to 25° C. A presently preferred temperature is 300° C.

In one preferred embodiment, the helically stranded thermoplastic polymer composite cable includes a plurality of thermoplastic polymer composite wires that are helically stranded in a lay direction to have a lay factor of from 6 to 150. The “lay factor” of a stranded cable is determined by dividing the length of the stranded cable in which a single wire 12 completes one helical revolution by the nominal outside of diameter of the layer that includes that strand.

While any suitably-sized thermoplastic polymer composite wires can be used, it is preferred for many embodiments and many applications that the thermoplastic polymer composite wires have a diameter from 1 mm to 4 mm, however larger or smaller thermoplastic polymer composite wires can be used.

The thermoplastic polymer composite wires may be stranded or helically wound as is known in the art on any suitable cable stranding equipment, such as planetary cable stranders available from Cortinovis, Spa, of Bergamo, Italy, and from Watson Machinery International, of Patterson, N.J. In some embodiments, it may be advantageous to employ a rigid strander, or a capstan to achieve a core tension greater than 100 kg, as is known in the art.

In some exemplary embodiments, the use of thermoplastic polymer composite wires improves upon conventional stranding processes using thermoset polymer composite wires. An exemplary thermoset stranding process is described, for example, in U.S. Pat. No. 5,126,167. The process uses thermoset polymer composite wires comprising an uncured thermoset resin in the polymer matrix of the polymer composite wires. The handling, winding on bobbins, and processing of wires containing uncured resins is difficult compared with the handling of fully formed and cured thermoplastic polymer composite wires. The use of thermoplastic polymer composite wires can also reduce manufacturing costs. In addition conventional equipment and bobbins may be utilized.

During the cable stranding process, the center wire, or the intermediate unfinished helically stranded thermoplastic polymer composite cable which will have one or more additional layers wound about it, is pulled through the center of the various carriages, with each carriage adding one layer to the stranded cable. The individual wires to be added as one layer are simultaneously pulled from their respective bobbins while being rotated about the center axis of the cable by the motor driven carriage. This is done in sequence for each desired layer. The result is a helically stranded thermoplastic polymer composite core.

An exemplary apparatus 80 for making helically stranded thermoplastic polymer composite cables according to embodiments of the present disclosure is shown in FIG. 3. In general, helically stranded thermoplastic polymer composite cables according to the present disclosure can be made by stranding polymer composite wires around a single wire in the same lay direction, as described above. The single wire may comprise a polymer composite wire or a ductile wire. At least two layers of thermoplastic polymer composite wires are preferably formed by stranding thermoplastic polymer composite wires about the single wire core, for example, 19 or 37 wires formed in at least two layers around a single center wire, as shown in FIG. 1B.

A spool of wire 81 used to provide the single center wire 2 of the helically stranded thermoplastic polymer composite cable is provided at the head of conventional planetary stranding machine 80, wherein spool 81 is free to rotate, with tension capable of being applied via a braking system where tension can be applied to the core during payoff (in some embodiments, in the range of 0-91 kg (0-200 lbs.)). The single wire 90 is threaded through bobbin carriages 82, 83, through the closing dies 84, 85, around capstan wheels 86 and attached to take-up spool 87. The spool of wire 81 may comprise a composite wire, for example, a thermosetting polymer composite wire, a thermoplastic polymer composite wire, or a metal matrix composite wire. Alternatively, the spool of wire 81 may comprise a metal wire, for example, a ductile metal wire.

In exemplary embodiments, the stranded thermoplastic composite cable passes (e.g. is threaded) through heat sources 96 and 97. Closing dies 84 and 85 may also incorporate heating elements. The heat sources supply sufficient heat for a sufficient time to allow the wires to plastically deform. The heat sources may be sufficiently long to provide a resident heating time sufficient to heat the polymer composite cable to a temperature such that the thermoplastic polymer composite wires plastically deform.

Various heating methods may be used, including for example convective heating with air, and radiative heating as with a tube furnace. Alternatively the cable may be passed through a heated liquid bath. Alternatively the stranded cable can be wound on a spool and then heated in an oven for a sufficient temperature and period of time so that the wires plastically deform.

Prior to the application of the outer stranding layers, individual thermoplastic polymer composite wires are provided on separate bobbins 88 which are placed in a number of motor driven carriages 82, 83 of the stranding equipment. In some embodiments, the range of tension required to pull thermoplastic polymer composite wires 89A, 89B from the bobbins 88 is typically 4.5-22.7 kg (10-50 lbs.). Typically, there is one carriage for each layer of the finished helically stranded thermoplastic polymer composite cable. Thermoplastic polymer composite wires 89 A, 89B of each layer are brought together at the exit of each carriage at a closing die 84, 85 and arranged over the center wire or over the preceding layer.

Layers of thermoplastic polymer composite wires comprising the helically stranded thermoplastic polymer composite cable are helically stranded as previously described. During the stranding process, the center wire, or the intermediate unfinished helically stranded thermoplastic polymer composite cable which may have one or more additional layers wound about it, is pulled through the center of the various carriages, with each carriage adding one layer to the stranded cable. The individual wires to be added as one layer are simultaneously pulled from their respective bobbins while being rotated about the center axis of the cable by the motor driven carriage. This is done in sequence for each desired layer. The result is a helically stranded thermoplastic polymer composite cable 91 that can be cut and handled conveniently without loss of shape or unraveling.

In some exemplary embodiments, helically stranded thermoplastic polymer composite cables comprise helically stranded thermoplastic polymer composite wires having a length of at least 100 meters, at least 200 meters, at least 300 meters, at least 400 meters, at least 500 meters, at least 1000 meters, at least 2000 meters, at least 3000 meters, or even at least 4500 meters or more.

The single center wire material and thermoplastic polymer composite wires for a given layer are brought into intimate contact via closing dies. Referring to FIG. 3, closing dies 84, 85 are typically sized to minimize the deformation stresses on the thermoplastic polymer composite wires of the layer being wound. The internal diameter of the closing die is tailored to the size of the external layer diameter. To minimize stresses on the wires of the layer, the closing die is sized such that it is in the range from 0-2.0% larger, relative to the external diameter of the cable. (i.e., the interior die diameters are in a range of 1.00 to 1.02 times the exterior cable diameter). Exemplary closing dies are cylinders, and are held in position, for example, using bolts or other suitable attachments. The dies can be made, for example, of hardened tool steel.

The resulting finished helically stranded thermoplastic polymer composite cable may pass through other stranding stations, if desired, and ultimately wound onto take-up spool 87 of sufficient diameter to avoid cable damage. In some embodiments, techniques known in the art for straightening the cable may be desirable. For example, the finished cable can be passed through a straightener device comprised of rollers (each roller being for example, 10-15 cm (4-6 inches), linearly arranged in two banks, with, for example, 5-9 rollers in each bank. The distance between the two banks of rollers may be varied so that the rollers just impinge on the cable or cause severe flexing of the cable. The two banks of rollers are positioned on opposing sides of the cable, with the rollers in one bank matching up with the spaces created by the opposing rollers in the other bank. Thus, the two banks can be offset from each other. As the helically stranded thermoplastic polymer composite cable passes through the straightening device, the cable flexes back and forth over the rollers, allowing the strands in the conductor to stretch to the same length, thereby reducing or eliminating slack.

In some exemplary embodiments, it may be desirable to provide the single center wire at an elevated temperature (e.g., at least 25° C., 50° C., 75° C., 100° C., 125° C., 150° C., 200° C., 250° C., 300° C., 400° C., or even, in some embodiments, at least 500° C.) above ambient temperature (e.g., 22° C.). The single center wire can be brought to the desired temperature, for example, by heating spooled wire (e.g., in an oven for several hours). The heated spooled wire is placed on the pay-off spool (see, e.g., pay-off spool 81 in FIG. 3) of a stranding machine. Desirably, the spool at elevated temperature is in the stranding process while the wire is still at or near the desired temperature (typically within about 2 hours).

In further exemplary embodiments, it may be desirable to provide all of the wires at an elevated temperature (e.g., at least 25° C., 50° C., 75° C., 100° C., 125° C., 150° C., 200° C., 250° C., 300° C., 400° C., or even, in some embodiments, at least 500° C.) above ambient temperature (e.g., 22° C.). The wires can be brought to the desired temperature, for example, by heating spooled wire (e.g., in an oven for several hours). The heated spooled wire is placed on the pay-off spool (see, e.g., pay-off spool 81 and bobbins 88A and 88B in FIG. 3) of a stranding machine. Desirably, the spool at elevated temperature is in the stranding process while the wire is still at or near the desired temperature (typically within about 2 hours)

In certain exemplary embodiments, it may be desirable to have a temperature differential between the single wire and the thermoplastic polymer composite wires which form the outer thermoplastic polymer composite layers during the stranding process. In further embodiments, it may be desirable to conduct the stranding with a single wire tension of at least 100 kg, 200 kg, 500 kg, 1000 kg., or even at least 5000 kg.

The ability to handle the helically stranded thermoplastic polymer composite cable is a desirable feature. Although not wanting to be bound by any particular theory, the helically stranded thermoplastic polymer composite cable is believed to maintain its helically stranded arrangement because during manufacture when the thermoplastic wires are heated, the thermoplastic polymer composite wires are subjected to stresses, including bending stresses, beyond the yield stress of the wire material but below the ultimate or failure stress. This stress is imparted as the thermoplastic polymer composite wires are helically wound about the relatively small radius of the preceding layer or center wire. Additional stresses are imparted at closing dies 84, 85 which apply radial and shear forces to the cable during manufacture. However, when heated to a sufficient temperature, thermoplastic polymer composite wires plastically deform, and the stresses within the wires are relaxed. The bending stresses and other imparted stresses in the polymer composite wires during stranding may thus be greatly reduced or even eliminated (i.e., reduced to zero) if the stranded polymer composite wires in a helically stranded polymer composite cable are heated to a temperature sufficient to soften the polymer matrix within the stranded wires, causing the polymer composite wires to adhere to each other and thereby retain their helically stranded configuration upon cooling to 25° C.

Thus, in certain presently preferred exemplary embodiments, the thermoplastic polymer composite wires are heated to a temperature at least above the glass transition temperature of the (co)polymer matrix material forming the thermoplastic polymer composite wire for a time sufficient for the thermoplastic polymer to undergo stress relaxation. In some exemplary embodiments, the thermoplastic polymer composite wires in the helically stranded thermoplastic polymer composite cable are heated to a temperature of at least 50° C., more preferably at least 100° C., 150° C., 200° C., 250° C., 300° C., 350° C., 400° C., 450° C. or even at least 500° C.

Preferably, the thermoplastic polymer composite wires in the helically stranded thermoplastic polymer composite cable are not heated to a temperature above the melting temperature of the thermoplastic (co)polymer matrix. In some embodiments the resident heating time can be less than one minute. In other exemplary embodiments, the thermoplastic polymer composite wires in the helically stranded thermoplastic polymer composite cable are heated for a period of time of at least 1 minute, 2 minutes, 5 minutes, 10 minutes, 20 minutes, one half hour, more preferably 1 hour, 1.5 hours, or even two hours.

Helically stranded thermoplastic polymer composite cables of the present disclosure are useful in numerous applications. Such helically stranded thermoplastic polymer composite cables are believed to be particularly desirable for use as electrical power transmission cables, which may include overhead, underground, and underwater electrical power transmission cables, due to their combination of low weight, high strength, good electrical conductivity, low coefficient of thermal expansion, high use temperatures, and resistance to corrosion.

Thus, in a further aspect, the present disclosure provides various embodiments of a stranded electrical power transmission cable comprising a helically stranded thermoplastic polymer composite core and a conductor layer around the helically stranded thermoplastic polymer composite core, and in which the helically stranded thermoplastic polymer composite core comprises any of the above-described helically stranded thermoplastic polymer composite cables. In some embodiments, the electrical power transmission cable may be useful as an overhead electrical power transmission cable, an underground electrical power transmission cable, or an underwater electrical power transmission cable, such as an underwater tether or underwater umbilical. In certain exemplary embodiments, the conductor layer comprises a metal layer which contacts substantially an entire surface of the helically stranded thermoplastic polymer composite cable core. In other exemplary embodiments, the conductor layer comprises a plurality of ductile metal conductor wires stranded about the helically stranded thermoplastic polymer composite cable core.

The helically stranded thermoplastic polymer composite cables may be used as intermediate articles that are later incorporated into final articles, for example, towing cables, hoist cables, electrical power transmission cables, and the like, by stranding a multiplicity of ductile metal wires around a core comprising helically stranded thermoplastic polymer composite wires, for example, the helically stranded thermoplastic polymer composite cables previously described, or other helically stranded thermoplastic polymer composite cables. For example, the core can be made by helically stranding two or more layers of thermoplastic polymer composite wires (4, 6, 8) around a single center wire (2) as described above using techniques known in the art. Typically, such helically stranded thermoplastic polymer composite cable cores tend to comprise as few as 19 individual wires to 50 or more wires.

The electrical power transmission cable (or any of the individual wires used in forming the helically stranded thermoplastic polymer composite cable) may optionally be surrounded by an insulative layer or sheath. An armor layer or sheath may also be used to surround and protect the electrical power transmission cable (or any of the individual wires used in forming the helically stranded thermoplastic polymer composite cable).

The electrical power transmission cable may include two or more optional layers of ductile metal conductor wires. More layers of ductile metal conductor wires (not shown in the FIGs.) may be used as desired. When used as an electrical power transmission cable, the optional ductile metal wires may act as electrical conductors, i.e. ductile metal wire conductors. Preferably, each conductor layer comprises a plurality of ductile metal conductor wires as is known in the art. Suitable materials for the ductile metal conductor wires include aluminum and aluminum alloys. The ductile metal conductor wires may be stranded about the helically stranded thermoplastic polymer composite core by suitable cable stranding equipment as is known in the art (see, e.g. FIG. 3).

The weight percentage of polymer composite wires within the electrical power transmission cable will depend upon the design of the transmission line. In the electrical power transmission cable, the aluminum or aluminum alloy conductor wires may be any of the various materials known in the art of overhead power transmission, including, but not limited to, 1350 Al (ASTM B609-91), 1350-H19 Al (ASTM B230-89), or 6201 T-81 Al (ASTM B399-92).

A presently preferred application of the electrical power transmission cable is as an overhead electrical power transmission cable, an underground electrical power transmission cable, or an underwater electrical power transmission cable, such as a underwater tether or an underwater umbilical. For a description of suitable overhead electrical power transmission cables, underground electrical power transmission cables, underwater electrical power transmission cables, underwater tethers and underwater umbilicals, see for example, copending Provisional U.S. Pat. App. No. 61/226,151 (“INSULATED COMPOSITE POWER CABLE AND METHOD OF MAKING AND USING SAME”, filed Jul. 16, 2009) and copending Provisional U.S. Pat. App. No. 61/226,056 (“SUBMERSIBLE COMPOSITE CABLE AND METHODS”, filed Jul. 16, 2009). For a description of suitable electrical power transmission cables and processes in which the stranded cable of the present disclosure may be used, see, for example, Standard Specification for Concentric Lay Stranded Aluminum Conductors, Coated, Steel Reinforced (ACSR) ASTM B232-92; or U.S. Pat. Nos. 5,171,942 and 5,554,826.

In these electrical power transmission applications, the thermoplastic (co)polymer(s) comprising the polymeric matrix of the thermoplastic polymer composite wires should be selected for use at temperatures of at least 100° C., or 240° C., or 300° C., depending on the application. In this regard, polyetheretherketone is a presently preferred (co)polymer for use in the polymeric matrix of the thermoplastic polymer composite wires.

In other applications, in which the helically stranded thermoplastic polymer composite cable is to be used as a final article itself, or in which it is to be used as an intermediary article or component in a different subsequent article, it may be preferred that the helically stranded thermoplastic polymer composite cable be free of electrical power conductor layers around the plurality of thermoplastic polymer composite wires.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

### Example 1

NEXTEL/PEEK polymer composite wires were made by infiltrating two 10,000 rovings of NEXTEL 610 alpha alumina fibers (obtained from 3M Company, St. Paul, Minn.) with polyetheretherketone (PEEK) thermoplastic polymer (available from VITREX PLC, West Conshohocken, Pa.). The method of producing continuous lengths of fiber reinforced polymer composite wires is known in the art (see e.g. U.S. Pat. No. 4,680,224, and PCT Pat. Pub. WO 2005/123999). The fabrication of such polymer composite wires was carried out using such conventional composite wire fabrication methods (at Tencate Advanced Composites, Taunton, Mass.).

A bench-top, hand-operated wire strander was used to make a helically stranded cable from the NEXTEL/PEEK polymer composite wires. A 7 strand cable was constructed, consisting of 6 outer polymer composite wires helically stranded about a central polymeric composite core wire. Several cable lengths were produced, one section having a 6 inch (15.24 cm) lay length, the other having a 3 inch (7.62 cm) lay length. The diameter of the polymer composite wire used was 0.05 inch (1.27 mm). The diameters of the polymer composite cables produced were 0.15 inches (3.81 mm). The cables were wrapped at the ends with adhesive tape to prevent the individual polymer composite wires from springing back and unwinding. At this point in the process, the wires were only elastically deformed.

The different cable lengths were annealed for 1 hour at temperatures of 200° C., 250° C., and 300° C. The annealed stranded polymer composite cables were subsequently evaluated to determine the degree to which the wires in the cables took a permanent set. The tape retaining the ends of the stranded polymer composite wires was removed and the cable ends released.

The annealed stranded polymer composite cables were qualitatively graded with respect to their retention of a permanent set, the grades ranging from no set, some set, more set, to almost complete set. The results are summarized in Table 1.

TABLE 1

| | Lay Length | Temperature | Degree of |
|---|---|---|---|
| Sample ID | (inches/cm) | (° C.) | Permanent Set |
| 1 | 3 (7.62) | No Heating | No Set |
| 2 | 3 (7.62) | 200 | Some Set |
| 3 | 3 (7.62) | 250 | More Set |
| 4 | 3 (7.62) | 300 | Nearly Complete Set |
| 5 | 6 (15.24) | No Heating | No Set |
| 6 | 6 (15.24) | 200 | Some Set |
| 7 | 6 (15.24) | 250 | More Set |
| 8 | 6 (15.24) | 300 | Nearly Complete Set |

As can be seen in Table 1, the process of annealing the stranded NEXTEL/PEEK polymer composite cables by exposing the stranded polymer composite wires to heat for a period of time sufficient to at least partially soften the polymer matrix results in the polymer composite wires in the cable taking a permanent helical set, so that the cable retains its stranded integrity construction when the ends of the polymer composite wires are unconstrained. Various degrees of set may be obtained by varying the annealing temperature and time. In general, higher annealing temperatures and longer annealing times tend to increase the degree of set of the helically stranded polymer composite wires in the polymer composite cables. However, it is understood that the time and temperature should be maintained below conditions which cause any substantial degradation of the polymer matrix or the reinforcing fibers.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g. 1 to 5 includes 1, 1.5, 2, 2.75, 3, 3.80, 4, and 5). In addition, all numbers used herein are assumed to be modified by the term ‘about’.

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A stranded cable, comprising:
a single wire defining a center longitudinal axis;
a first plurality of thermoplastic polymer composite wires helically stranded around the single wire in a first lay direction at a first lay angle defined relative to the center longitudinal axis and having a first lay length;
a second plurality of thermoplastic polymer composite wires helically stranded around the first plurality of thermoplastic polymer composite wires in a second lay direction at a second lay angle defined relative to the center longitudinal axis and having a second lay length; and
a plurality of ductile metal wires stranded around the single wire defining a center longitudinal axis,
wherein the plurality of ductile metal wires comprise at least one metal selected from the group including zirconium, copper, tin, cadmium, aluminum, manganese, zinc, cobalt, nickel, chromium, titanium, tungsten, vanadium, their alloys with each other, their alloys with other metals, their alloys with silicon, and combinations thereof.

2. (canceled)

3. The stranded cable of claim 1, wherein the single wire is a polymer composite wire, a thermoplastic polymer composite wire, or a ductile metal wire.

4. The stranded cable of claim 3, wherein each of the polymer composite wires is substantially continuous and at least 150 m long.

5. The stranded cable of claim 1, wherein each thermoplastic polymer composite wire has a cross-section in a direction substantially normal to the center longitudinal axis, and wherein a cross-sectional shape of each polymer composite wire is selected from the group including circular, elliptical, and trapezoidal.

6. (canceled)

7. The stranded cable of claim 1, wherein each of the first plurality of thermoplastic polymer composite wires and the second plurality of thermoplastic polymer composite wires has a lay factor of from 10 to 150.

8. The stranded cable of claim 7, wherein the first lay direction is the same as the second lay direction.

9. The stranded cable of claim 8, wherein a relative difference between the first lay angle and the second lay angle is greater than 0° and no greater than about 4°.

10. The stranded cable of claim 1, further comprising a third plurality of thermoplastic polymer composite wires helically stranded around the second plurality of thermoplastic polymer composite wires in a third lay direction at a third lay angle defined relative to the center longitudinal axis and having a third lay length.

11. (canceled)

12. (canceled)

13. (canceled)

14. The stranded cable of claim 10, further comprising a fourth plurality of polymer composite wires helically stranded around the third plurality of polymer composite wires in a fourth lay direction at a fourth lay angle defined relative to the center longitudinal axis and having a fourth lay length.

15. (canceled)

16. (canceled)

17. (canceled)

18. The stranded cable of claim 1, wherein each of the polymer composite wires comprises a fiber reinforced polymer matrix.

19. (canceled)

20. The stranded cable of claim 18, wherein the fiber reinforced polymer matrix comprises at least one fiber selected from metal fibers, polymer fibers, carbon fibers, ceramic fibers, glass fibers, or combinations thereof.

21. (canceled)

22. (canceled)

23. The stranded cable of claim 18, wherein the fiber reinforced polymer matrix comprises a (co)polymer selected from the group including an epoxy, an ester, a vinyl ester, a polyimide, a polyester, a cyanate ester, a phenolic resin, a bis-maleimide resin, polyetheretherketone, and combinations thereof.

24. The stranded cable of claim 18, wherein the fiber reinforced polymer matrix comprises a thermoplastic (co)polymer.

25. The stranded cable of claim 1, further comprising at least one fiber reinforced metal matrix composite wire further comprising at least one continuous fiber in a metal matrix, wherein at least a portion of the thermoplastic polymer composite wires surrounds the at least one fiber reinforced metal matrix composite wire.

26. The stranded cable of claim 25, wherein the at least one continuous fiber comprises a material selected from the group including ceramics, glasses, carbon nanotubes, carbon, silicon carbide, boron, iron, steel, ferrous alloys, tungsten, titanium, shape memory alloy, and combinations thereof.

27. (canceled)

28. (canceled)

29. (canceled)

30. (canceled)

31. (canceled)

32. (canceled)

33. The stranded cable of claim 1, wherein the plurality of ductile metal wires is stranded about the center longitudinal axis in a plurality of radial layers surrounding the thermoplastic polymer composite wires.

34. The stranded cable of claim 33, wherein each radial layer is stranded in a lay direction opposite to that of an adjoining radial layer.

35. (canceled)

36. (canceled)

37. (canceled)

38. (canceled)

39. (canceled)

40. A cable comprising a core and a conductor layer around the core, wherein the core comprises the stranded cable of claim 1.

41. (canceled)

42. The cable of claim 40 used for electrical power transmission.

43. (canceled)

44. (canceled)

45. A method of making the cable of claim 1, comprising:
helically stranding a first plurality of thermoplastic polymer composite wires about a single wire defining a center longitudinal axis, wherein helical stranding of the first plurality of thermoplastic polymer composite wires is carried out in a first lay direction at a first lay angle defined relative to the center longitudinal axis, and wherein the first plurality of thermoplastic polymer composite wires has a first lay length; and
helically stranding a second plurality of thermoplastic polymer composite wires around the first plurality of thermoplastic polymer composite wires, wherein helical stranding of the second plurality of thermoplastic polymer composite wires is carried out in the first lay direction at a second lay angle defined relative to the center longitudinal axis, and wherein the second plurality of thermoplastic polymer composite wires has a second lay length;
heating the helically stranded first and second plurality of thermoplastic polymer composite wires to a temperature sufficient to retain the helically stranded polymer composite wires in a helically stranded configuration upon cooling to 25° C.; and
stranding a plurality of ductile metal wires around the single wire defining a center longitudinal axis.

46. (canceled)

47. (canceled)
